(19) United States
(12) Patent Application Publication
(10) Pub. No.: US 2020/0003487 A1
(43) Pub. Date: Jan. 2, 2020

(54) TEMPERATURE REGULATED APPARATUSES AND METHODS OF USING SAME

(71) Applicant: FUSE, LLC, Memphis, TN (US)

(72) Inventor: Matthew S. Brown, Falkner, MS (US)

(21) Appl. No.: 16/458,821

(22) Filed: Jul. 1, 2019

Related U.S. Application Data
(60) Provisional application No. 62/692,685, filed on Jun. 30, 2018.
(60) Provisional application No. 62/820,597, filed on Mar. 19, 2019.

(51) Int. Cl. F25D 31/00; F25D 3/00; F25D 3/06; H05B 3/34

(52) U.S. Cl. CPC F25D 31/005; F25D 3/00; F25D 2400/02; H05B 3/342; F25D 3/06

(57) ABSTRACT

A temperature regulated apparatus can include a layered member comprising a first layer of material and a second layer of material connected to the first layer. The layered member can have a first opening formed therein and an interior area defined by the first layer and the second layer. The interior area can be in communication with the first opening. A temperature regulating element adapted to alter the temperature of the layered member can be positioned within the interior area of the layered member, and can be removed from the layered member without disassembling the layered member.

### CROSS REFERENCE TO RELATED APPLICATIONS

This application claims priority to U.S. Patent Application No. 62/692,685, filed Jun. 30, 2018, and U.S. Patent Application No. 62/820,597, filed Mar. 19, 2019. Both of said applications are incorporated by reference herein.

### TECHNICAL FIELD

The present invention relates to temperature regulated apparatuses. One embodiment of the invention comprises a temperature regulated pad. Another embodiment of the invention comprises a pet bed or pad having a heated side and a cooling side.

### BACKGROUND

Heated electric blankets are known in the art. Generally, such blankets must be handwashed rather washed in a conventional washing machine.

### SUMMARY

One object of the present invention is to provide a pad or cushion comprising a removable heating element. Another object of the invention is to provide a pad or cushion comprising a cooling element. Another object of the invention is to provide a pad or cushion comprising a heating element and a cooling element. These and other objects of the invention can be achieved in one or more embodiments of the invention described herein.

One embodiment of the invention comprises a pad, cushion or bed having a removable temperature altering element.

According to an embodiment of the invention, the temperature altering element can be a heating element.

According to another embodiment of the invention, the temperature altering element can be a cooling element.

Another embodiment of the invention comprises a pad, seat, cushion, blanket or bed comprising a removable heating element and a removable cooling element.

Another embodiment of the invention comprises a kit comprising a heating element, a cooling element, and a pad having a first side adapted to receive the heating element and a second side adapted to receive the cooling element.

Another embodiment of the invention comprises a temperature regulating insert assembly adapted for use in a container.

Another embodiment of the invention comprises a container apparatus comprising a container and a temperature regulating insert assembly received and releasably maintained within a substantially concave recess formed in the interior surface of the container. According to an embodiment of the invention, the container can be a thermally insulated cooler, and the temperature regulating insert assembly comprises a dispensing mechanism that dispenses a cooling gas into the interior of the cooler.

According to an embodiment of the invention, the temperature regulating insert assembly does not alter the form, fit or function of the container in which it is positioned.

Another embodiment of the invention comprises a temperature regulated apparatus comprising a layered member comprising a first layer of material and a second layer of material attached to the first layer. The layered member has a first opening formed therein and an interior area defined by the first layer and the second layer. The interior area is in communication with the first opening. A temperature regulating element adapted to alter the temperature of the layered member is positioned within the interior area of the layered member. The temperature regulating element is not operatively connected to the layered member and can be removed from the layered member without disassembling the layered member.

According to an embodiment of the invention, the temperature regulated apparatus comprises a heating element adapted to heat the layered member.

According to an embodiment of the invention, the heating element can be a flexible heating sheet or an electric heated blanket.

According to an embodiment of the invention, the heating element includes a rechargeable battery for powering the heating element. An electrical cord is operatively connected to the rechargeable battery and a power source for charging the rechargeable battery.

According to an embodiment of the invention, the layered member has a second opening formed therein, which is in communication with the interior area of the layered member. The electrical cord can be positioned through the second opening.

According to an embodiment of the invention, the first layer and/or the second layer comprise cushioning.

According to an embodiment of the invention, the layered member can be a pad, a bed or a seat cushion.

According to an embodiment of the invention, the temperature regulating element comprises a heating element adapted to increase the temperature of the layered member and/or a cooling element adapted to decrease the temperature of the layered member.

According to an embodiment of the invention, the temperature regulated apparatus includes at least one non-permanent fastener for releasably closing the first opening.

According to an embodiment of the invention, the non-permanent fastener comprises a magnet, a zipper, and/or hook and loop fasteners.

Another embodiment of the invention comprises a layered member comprising a heating section and a cooling section, the heating section defining a first side of the layered member and the cooling section defining a second side of the layered member opposite the first side. The layered member has a first opening in communication with a first interior area, and a second opening in communication with a second interior area. A heating element can be positioned within the first interior area. The heating element is adapted to increase the temperature of the layered member. The heating element is not operatively connected to the layered member, and is removable from the layered member without disassembling the layered member. A cooling element can be positioned within the second interior area. The cooling element is adapted to decrease the temperature of the layered member. The cooling element is not operatively connected to the layered member, and is removable from the layered member without disassembling the layered member.

According to an embodiment of the invention, a cushioning section can be positioned intermediate the heating element and the cooling element. The cushioning section separates the first interior area from the second interior area of the layered member.

According to an embodiment of the invention, the layered member comprises a first layer of material and a second layer of material connected to the first layer of material. The first layer and the second layer define opposed exterior sides of the layered member.

According to an embodiment of the invention, the cushioning section comprises at least one layer of material and is positioned intermediate the first layer and the second layer. The first layer and the cushioning section define the first interior area of the layered member. The second layer and the cushioning section define the second interior area.

According to an embodiment of the invention, the cooling element comprises a plurality of cooling members comprising a refrigerant gel, and the cooling section comprises a plurality of pockets sized and shaped to receive and retain the plurality of cooling members therein.

According to an embodiment of the invention, the heating element can be a flexible heating sheet and/or an electric heated blanket.

Another embodiment of the invention comprises a temperature regulating insert assembly comprising a housing and a gas contained in the housing that can alter the ambient temperature. The insert assembly dispenses the gas through at least one opening formed in the housing. The insert assembly can be positioned in a container, such as a thermally insulated cooler or other container.

Another embodiment of the invention comprises a temperature regulated container apparatus comprising a temperature regulating insert assembly comprising a housing and a gas contained in the housing that can alter the ambient temperature. The insert assembly is adapted to dispense the gas through at least one opening formed in the housing. The container apparatus comprises an enclosure comprising a base and at least one sidewall extending upwardly from the base, which defines an interior area within the enclosure. The enclosure has an interior surface and at least one substantially concave recess formed in the interior surface adapted to receive the insert assembly therein, wherein the ambient temperature in the interior area of the enclosure is altered when the insert assembly dispenses the gas.

According to an embodiment of the invention, the temperature regulating insert assembly comprises a control module comprising a thermostat. The control module is programmable to maintain a desired temperature within the interior area of the enclosure by causing gas to be dispensed from the housing of the insert assembly to maintain the desired temperature within the interior area of the enclosure.

According to an embodiment of the invention, gas can comprise carbon dioxide, freon, nitrogen, difluoroethane, trifluoroethane, and/or tetrafluoroethane.

According to an embodiment of the invention, the enclosure can be a thermally insulated cooler. The temperature regulating insert assembly is not operatively connected to the layered member and is removable from cooler.

### BRIEF DESCRIPTION OF THE DRAWINGS

FIG. 1 is perspective view of a temperature regulated apparatus according to an embodiment of the invention;

FIG. 2 is another perspective view of the apparatus of FIG. 1;

FIG. 3 is another perspective view of the apparatus of FIG. 1;

FIG. 4 is another perspective view of the apparatus of FIG. 1;

FIG. 5 is a partial perspective view of the apparatus of FIG. 1;

FIG. 6 is a partial perspective view of the apparatus of FIG. 1;

FIG. 7 is another partial perspective view of the apparatus of FIG. 1;

FIG. 8 is a perspective view of a temperature regulated apparatus according to another embodiment of the invention;

FIG. 9 is another perspective view of the apparatus of FIG. 8;

FIG. 10 is another perspective view of the apparatus of FIG. 8;

FIG. 11 is another perspective view of the apparatus of FIG. 8;

FIG. 12 is another perspective view of the apparatus of FIG. 8;

FIG. 13 is a side view of the apparatus of FIG. 8;

FIG. 14 is another perspective view of the apparatus of FIG. 8;

FIG. 15 is another perspective view of the apparatus of FIG. 8;

FIG. 16 is another perspective view of the apparatus of FIG. 8;

FIG. 17 is another perspective view of the apparatus of FIG. 8;

FIG. 18 is a schematic plan view of the apparatus of FIG. 8;

FIG. 19 is another schematic plan view of the apparatus of FIG. 8;

FIG. 20 is perspective view of a temperature regulating apparatus according to another embodiment of the invention;

FIG. 21 is another perspective view of the apparatus of FIG. 20;

FIG. 22 is a perspective view of a temperature regulated container apparatus according to an embodiment of the invention;

FIG. 23 is a top plan view of the apparatus of FIG. 22;

FIG. 24 is a front elevation view of a temperature regulating apparatus according to another embodiment of the invention;

FIG. 25 is a perspective view of a temperature regulated container apparatus according to another embodiment of the invention;

FIG. 26 is another perspective view of the apparatus of FIG. 25;

FIG. 27 is a schematic view of a temperature regulated container apparatus according to another embodiment of the invention; and

FIG. 28 is a schematic view of a temperature regulating apparatus according to another embodiment of the invention.

### DETAILED DESCRIPTION OF PREFERRED EMBODIMENTS

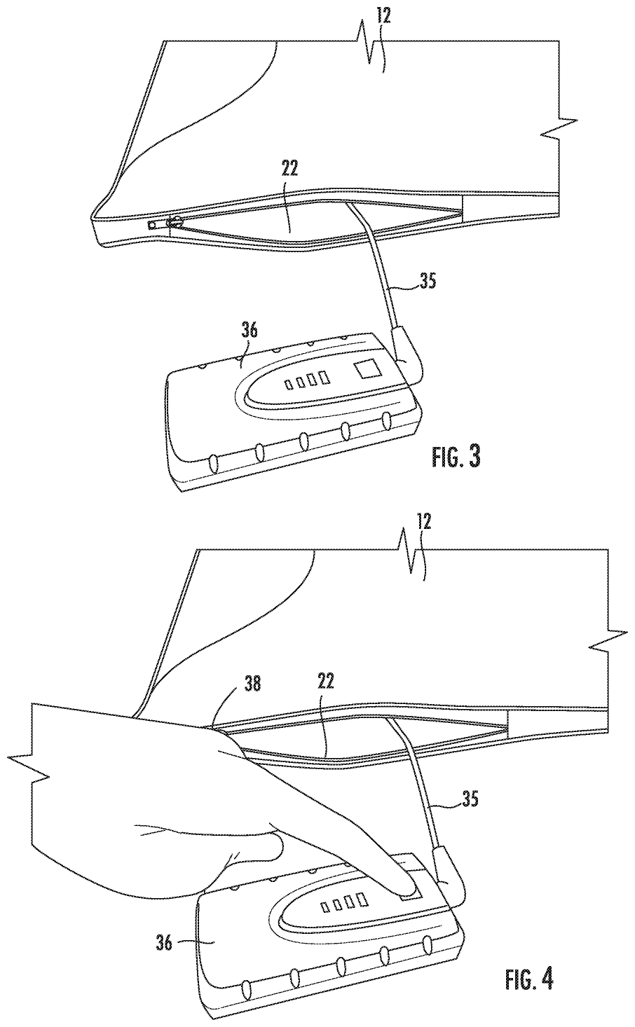

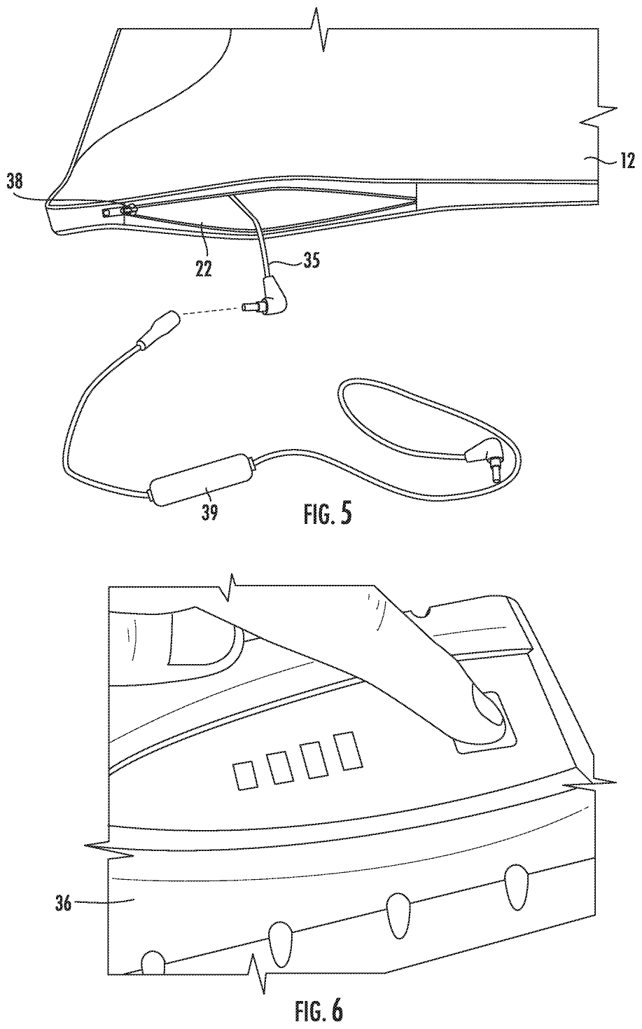

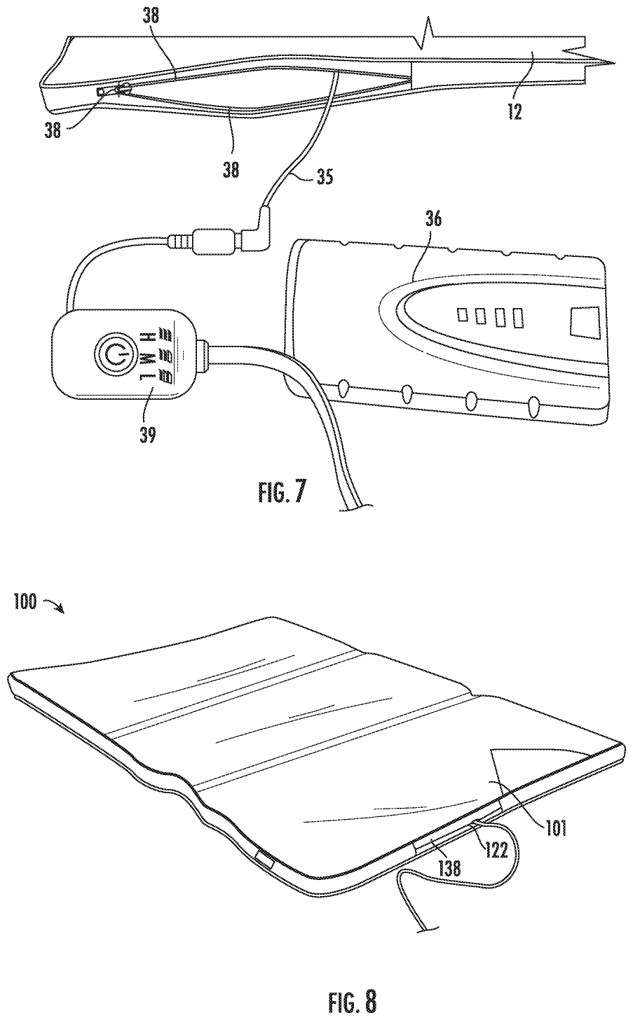

A temperature regulated apparatus according to a preferred embodiment of the invention is illustrated in FIGS. 1-7, and shown generally at reference numeral 10. The apparatus 10 comprises a layered member 12 having first and second layers. The layers can be comprised of cotton, polyester or other suitable material. Either or both of the layers can include cushioning, such as foam cushioning. The layered member 12 can be generally rectangular in shape, and the two layers can be sewn together or joined by other suitable attachment means along three sides. A first opening 21 is formed in one side of the layered member 12. The opening 21 can be opened and closed via non-permanent fasteners, such as hook and loop fasteners (VELCRO). Hook fasteners can be positioned on one layer, and loop fasteners can be positioned on the other layer. Alternatively, the fasteners can comprise magnets. Magnets can be positioned on one layer, and a plurality of members made of a material that is magnetically attracted to the magnets can be positioned on the other side. In another alternative embodiment, the opening can be opened and closed using a zipper.

A heating element is positioned in the interior of the layered member 12, in between the first and second layers. The heating element is adapted for conductively heating the pad 12. The heating element can be a flexible, rechargeable heater sheet. Alternatively, the heating element can be a rechargeable electric blanket. The heater sheet can be electrically connected to a DC electrical cord 35.

The heating element can be removed from the pad 12 by disengaging the fasteners to provide access to the interior of the pad 12 through the opening 21. Removal of the heating element from the pad 12 reduces the overall thickness and/or heaviness of the pad 12. As such, a user can reduce the overall thickness and/or heaviness of the apparatus 10 whenever desirable, such as when the ambient temperature is warm and the heating element is not desired. Also, the electrical heating element can be removed from the pad 12 to allow for washing of the pad 12.

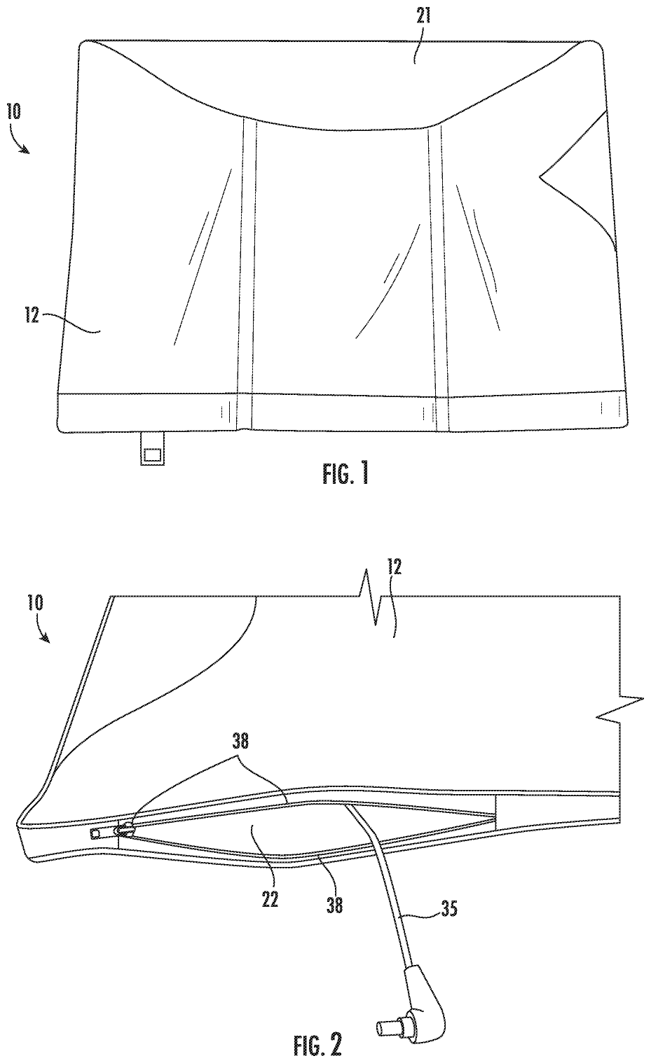

A second opening 22 is formed on a side of the pad 12 adjacent to the first opening 21, as shown in FIG. 2. The second opening 22 is relatively shorter in length than the first opening 21. The second opening 22 provides access to a small pocket formed in the pad 12. The opening 22 can be selectively opened and closed via non-permanent fasteners, such as a zipper 38. Alternatively, the fasteners can comprise hook and loop fasteners (VELCRO) or magnets.

The cord 35 can be positioned within the small pocket. When it is desired for the heating element to be connected to a power source, the zipper 38 is unzipped and the cord 35 is pulled out of the pocket and through the opening 22, as shown in FIG. 2. The DC cord 35 is plugged into a controller 39 that is operatively connected to a rechargeable battery 36. The controller 39 can have three power settings (HIGH, MEDIUM, LOW), as shown in FIG. 10, which allows for adjustment of the level of heat provided by the heating element. Setting the controller at HIGH results in about 100% of the full load operation, MEDIUM setting results in about 75%, and LOW setting results in about 50%. A direct power cord is not required to use the apparatus 10. The apparatus 10 only needs the cord 35 for charging, such as in the home or car.

In an alternative embodiment, the apparatus 10 can include wireless technology, such as the wireless communication technology sold under the mark “BLUETOOTH”, which is operatively connected to the battery 36. Software can be integrated into a mobile application 50 that can be downloaded onto mobile smartphones and allows a user to control percentage of power provided by the battery 36 to the heater sheet 31, and thus the level of heat provided by the apparatus 10, with a mobile smartphone. This provides for more accurate controlling of the percentage of power. Users can download the application at the APP STORE by searching the key word ELEHEAT.

According to an embodiment of the invention, the apparatus 10 can be used as a pet pad, providing a warm comfortable surface on which pets can lie. In another embodiment of the invention, the apparatus 10 can be a part of a pet bed. In another embodiment, the apparatus 10 can be integrated into a hand warmer. In alternative embodiments, the apparatus 10 can be integrated into furniture. For example, the apparatus 10 can be a component of a hunting seat for use in a deer blind, a hunting seat for use in a tree blind, and/or a fishing seat for use in ice fishing. In another embodiment, the apparatus can be integrated into a fold out chair that can be used at sporting and tailgating events. Another embodiment of the invention comprises a kit comprising a fold out seat and the apparatus 10. The apparatus 10 can be removably positioned on the seat of the fold out chair. According to other embodiments, the apparatus 10 can be incorporated into livestock vests, livestock blankets, and sleeping bags.

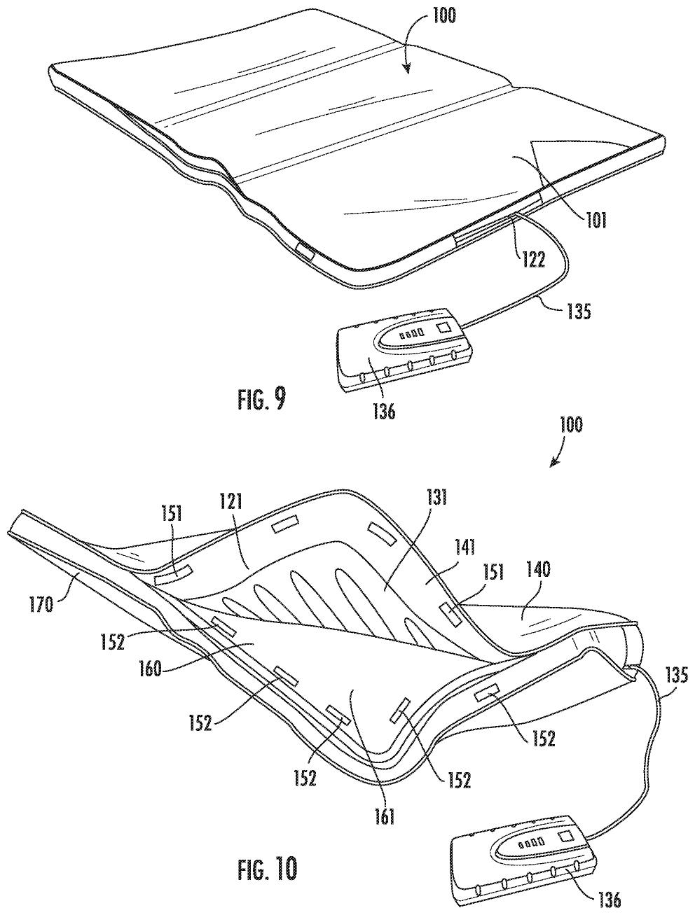

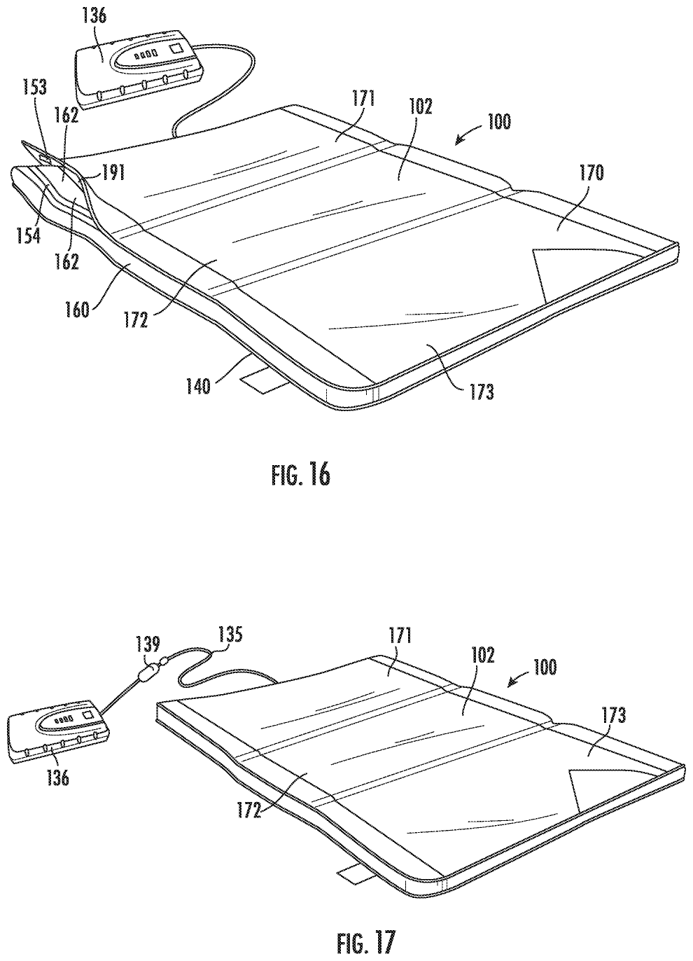

A temperature regulated apparatus according to another preferred embodiment of the invention is illustrated in FIGS. 8-19, and shown generally at reference numeral 100. The apparatus 100 comprises a layered member 112 having a first side comprising a heating section 101 and a second side opposite to the first side comprising a cooling section 102. The layered member 112 can be generally rectangular.

The layered member 112 comprises first and second outer layers of material 140, 170. The layers 140, 170 can be comprised of cotton, polyester, neoprene or other suitable material. An intermediate cushion section 160 can be positioned intermediate the first and second layers 140, 170, as shown in FIGS. 11 and 13. The intermediate cushion section 160 can be comprised of cotton, polyester, neoprene or other suitable material, and can include cushioning, such as foam cushioning. The intermediate cushion section has first and second opposed sides 161, 162.

Each of the first and second outer layers 140, 170 can be attached to the intermediate cushion section 160. Three sides of the first outer layer 140 can be sewn to the intermediate section 160 with red thread to indicate the heating section 101, and three sides of the second outer layer 170 can be sewn to the intermediate section 160 with blue thread to indicate the cooling section 102. Alternatively, the first and second outer layers 140, 170 can be attached to each other along three sides, such as by sewing or other permanent attachment means.

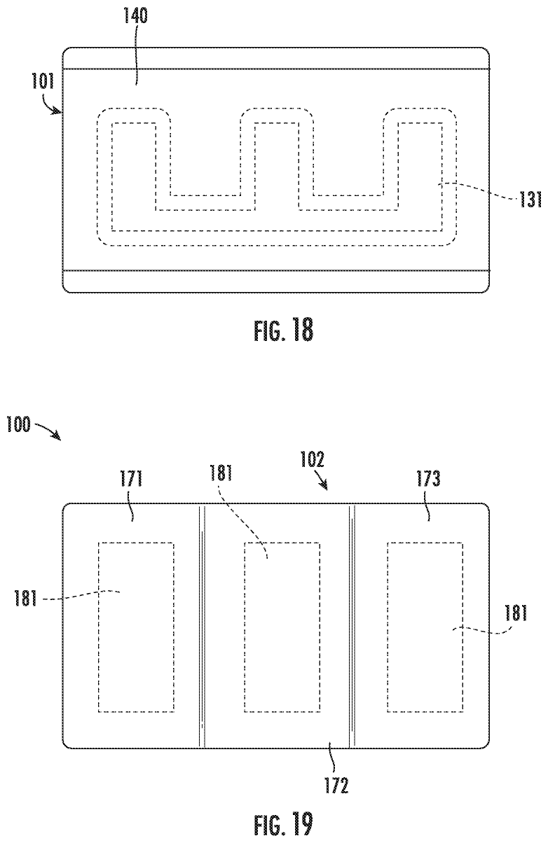

The first outer layer 140 and the first side 161 of the intermediate cushion section 160 define a first interior area 121, and the layered member 112 has a first opening in communication with the first interior area 121 to allow a user to access the first interior area 121. A heating element 131 is positioned within the first interior area 121, as shown in FIG. 11. The heating element 131 is shown in FIG. 18 in dotted lines, as the heating element is positioned under the first layer in the view of FIG. 18.

The heating element 131 is adapted for conductively heating the layered member 112. The heating element 131 can be a flexible heater sheet. The heater sheet 131 can comprise a layer of flexible, water resistant material that is embedded with a heat conductive wire that heats up when introduced to electricity. According to an embodiment of the invention, the heating element 131 can comprise the flexible heating sheet described in U.S. Pat. No. 7,265,324, which is incorporated herein by reference. According to an embodiment of the invention, the heater element 131 can comprise the ultra-thin flexible heater sold by PTI Pelonis Technologies, Inc. Alternatively, the heating element 131 can be a rechargeable electric blanket or heating pad. According to an embodiment of the invention, the heating element can be the silicone rubber heating blanket sold by Briskheat Corporation under the mark BRISKHEAT.

As shown in FIG. 11, non-permanent complementary fasteners 151, 152 are positioned on the interior of the first outer layer 141 and the first side 161 of the intermediate cushion section 160 to allow for opening and closing of the opening to the first interior area 121. The fasteners 151, 152 can be hook and loop fasteners, with hook fasteners 151 located on first layer 141, and loop fasteners 152 located on side 161. Alternatively, the fasteners can be magnets or a zipper. The opening of the first interior area 121 can be closed by engaging the hook fasteners 151 with the loop fasteners 152, and opened by disengaging the hook and loop fasteners 151, 152.

The heating element 131 is not operatively connected to the layered member 112. That is, the heating element is not electrically connected to the layered member 112 and can function independently from the layered member 112. The heating element 131 can be easily removed from the layered member when desired.

The heating element 131 can be removed from the layered member 112 by disengaging the hook and loop fasteners 151, 152 to provide access to the interior area 121 of the heating section 101, and pulling the heater element 131 out through the opening 121. As such, the heating element 131 can be removed from the layered member 112 without disassembling or damaging the layered member 112 in any way. This allows a user to reduce the overall thickness and/or heaviness of the apparatus 100 when desirable, such as when the ambient temperature is warm and the heating element 131 is not needed. Also, the heating element 131 can be removed from the layered member 112 to allow for washing of the layered member 112. Removal of the heating element 131 does not harm the structural integrity of the apparatus 100.

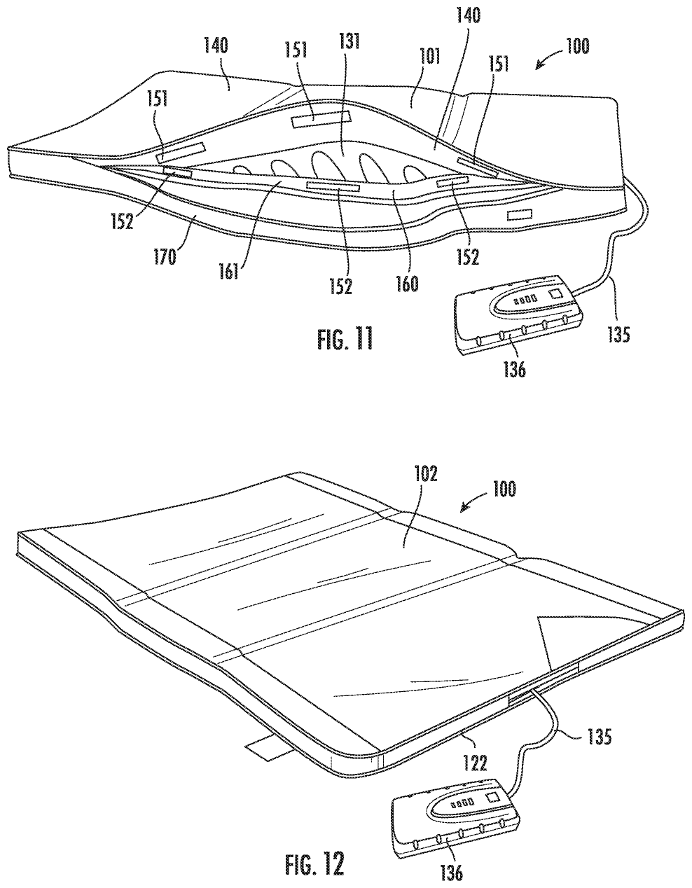

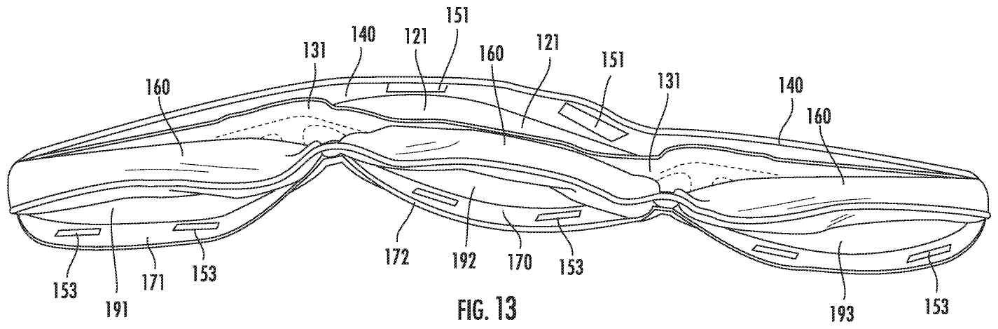

The heater sheet 131 can be powered by a rechargeable battery 136. The heater sheet 131 can be electrically connected by a DC electrical cord 135 to the rechargeable battery 136. A second opening 122 can be formed on a side of the heating section 101 adjacent to the first opening 121. The second opening 122 can be relatively shorter in length than the first opening 121. The second opening 122 provides access the interior area within the warming section 101, in which the battery 136 can be positioned. A zipper 138 is attached at the opening 122 by which the opening 122 can be selectively opened and closed. Alternatively, hook and loop fasteners or a magnet can be used in place of the zipper to open and close the opening 122. The battery 136 can be pulled out of the warming section 101 through the opening 122, as shown in FIGS. 11 and 12, to be recharged.

The DC cord 135 can be plugged into a controller 139 that is operatively connected to the battery 136. The controller 139 can have three power settings (HIGH, MEDIUM, LOW), which allows for adjustment of the level of heat provided by the electric blanket 131. Setting the controller at HIGH results in about 100% of the full load operation, MEDIUM setting results in about 75%, and LOW setting results in about 50%.

A direct power cord is not required to use the apparatus 100. The apparatus 100 only needs the cord 135 for charging, such as in the home or car.

In an alternative embodiment, the apparatus 100 can include wireless technology, such as the wireless communication technology sold under the mark “BLUETOOTH”, which is operatively connected to the battery 136. Software can be integrated into a mobile application that can be downloaded onto mobile smartphones and allows a user to control percentage of power provided by the battery 136 to the blanket 131 and thus the level of heat provided by the apparatus 100, with a mobile smartphone. This provides for more accurate controlling of the percentage of power. Users can download the application at the APP STORE by searching the key word “ELEHEAT.”

The second outer layer 170 and the second side 162 of the intermediate cushion section 160 define a second interior area that can be comprised of three distinct interior spaces 191, 192, 193. The second outer layer 170 can be attached to the second side 162 along three sides of the second outer layer 170 and along two additional lines traversing the second outer layer 170 to form three pockets 171, 172, 173 defining three interior spaces 191, 192, 193, respectively. The second outer layer 170 can be sewn to the cushion section 160 with blue thread indicating the cooling section 102.

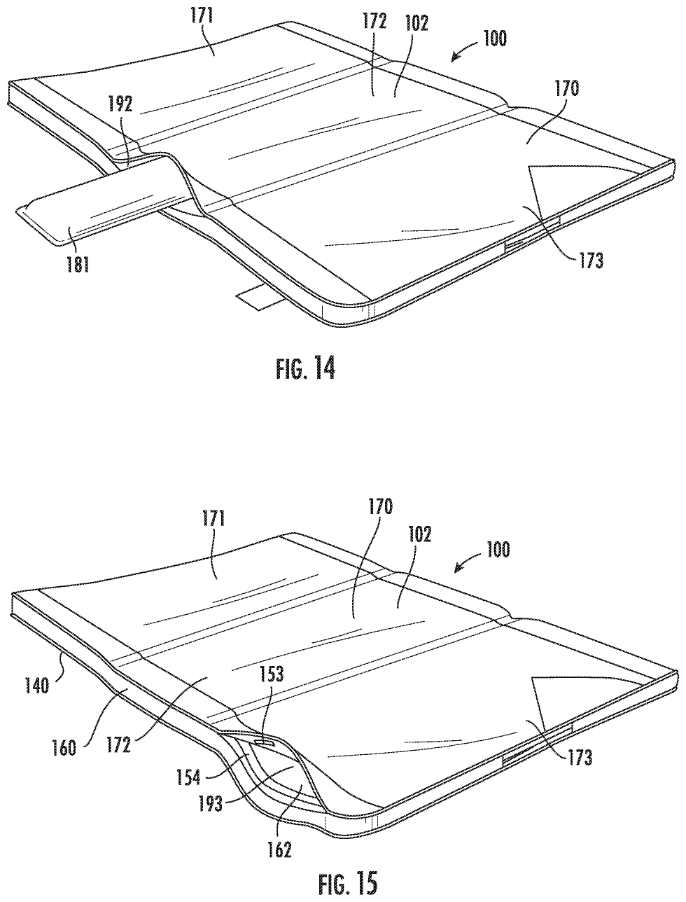

The cooling section 102 of the apparatus 100 can include a cooling element 181 that can lower the temperature of the layered member 112. The cooling element 181 can comprise a plurality of reusable refrigerant gel packs, such as the water-activated flexible gel packs sold by ThermaFreeze Products Corporation under the name “THERMAFREEZE 1 ounce Cubes.” Alternatively, the cooling element 181 can be the reusable cold pack sold under the name THERA-MED. In another alternative embodiment, the cooling element 181 can comprise a package containing a gel formulation comprised of propylene glycol and water. Other refrigerant gel compositions are described in U.S. Pat. No. 4,357,809, which is incorporated by reference herein. Each pocket 171, 172, 173 is shaped and sized to receive and retain one of the cooling pads 181, as shown in FIGS. 14 and 19. The cooling pads 181 are shown in dotted lines in FIG. 19 as they are located under the second layer sections 171, 172, 173.

According to another embodiment, the cooling element can comprise a gas dispersing device comprising a cooling gas, such as carbon dioxide, freon and/or nitrogen gas, a fluorocarbon, such as difluoroethane, trifluoroethane, or tetrafluoroethane, or other suitable gas. The gas dispersing device can include a thermostat and a timer so that the cooling gas can be time released to maintain a desired temperature within the layered member 112. The cold gas can be circulated throughout the layered member 112 through a tubing to decrease the core temperature. Each pocket 171, 172, 173 can include ventilation openings for allowing the cold gas to pass therethrough.

Non-permanent complementary fasteners 153, 154 can be positioned on the interior of the second outer layer and the second side 162 of the intermediate section 160, respectively, for closing and opening the openings 191, 192, 193 of the pockets 171, 172, 173. The fasteners 153, 154 can be hook and loop fasteners, with hook fasteners 153 located on the second outer layer 170, and loop fasteners 154 located on the second side 162 of the intermediate section 160. Alternatively, the fasteners 153, 154 can be magnets or a zipper. The openings 191, 192, 193 can be closed by engaging the hook fasteners 153 with the loop fasteners 154, and opened by disengaging the hook and loop fasteners 153, 154, as shown in FIGS. 15 and 16.

According to another embodiment of the invention, the heating section 101 can include a plurality of pockets, wherein each pocket contains a heating element, such as a heater sheet therein.

In a method of using the apparatus 100 according to a preferred embodiment of the invention, the cooling pads 181 can be activated by pouring water on the pads 181 and placing the cooling pads 181 in a freezer. Once they are cold, the pockets 171, 172, 173 of the cooling section 102 of the apparatus 100 are opened by disengaging the hook and loop fasteners 153, 154, and a cooling pad 181 can be positioned within each of the pockets 171, 172, 173. When the cooling pads 181 are no longer cold, the user can disengage the hook and loop fasteners 153, 154 and remove the cooling pads 181 from the pockets 171, 172, 173, and place the cooling pads 181 back into a freezer to be cooled again for future use.

The cooling pads 181 can be removed without disassembling or damaging the layered member 112 in any way. This allows a user to reduce the overall thickness and/or heaviness of the apparatus 100 when desirable, such as when the ambient temperature is cold and the cooling pads 181 are not needed. Also, the cooling pads 181 can be removed from the layered member 112 to allow for washing of the layered member 112. The cooling pads 181 can be removed and replaced in the layered member 112 without harming the structural integrity of the apparatus 100.

According to an embodiment of the invention, the apparatus 100 comprises a pet pad on which pets, such as dogs and cats, can lie down. In another embodiment of the invention, the apparatus 100 can be a component of a pet bed. In alternative embodiments, the apparatus 100 can be integrated into furniture, such as patio furniture cushions. According to an embodiment of the invention, the apparatus 100 can be integrated into hunting seats in a deer blind and/or hunting seats in a tree blind. According to another embodiment, the apparatus 100 can be integrated into the seat portion of a chair. In another embodiment, the apparatus 100 can be integrated into a folding chair that can be used at sporting and tailgating events. The apparatus 100 can be integrated into the seat of the chair and/or serve as a seat cushion. Another embodiment of the invention comprises a kit comprised of a fold out seat and the apparatus 100. The apparatus 100 can be removably positioned on the seat of the fold out chair. According to another embodiment, the apparatus 100 can be incorporated into apparel, such as a shirt, jacket or vest. For example, the apparatus 100 can be integrated into a livestock vest. In another embodiment, the apparatus 100 can be a component of a blanket, such as a livestock blanket. Another embodiment of the invention comprises a sleeping bag that includes the apparatus 100. According to another embodiment of the invention, the apparatus 100 can be integrated into a backpack. In these embodiments, the apparatus 100 does not negatively impact the integrity of the underlying product, such as a chair, clothing, blanket or backpack. Nor does the apparatus 100 negatively impact the form, fit or function of the underlying product.

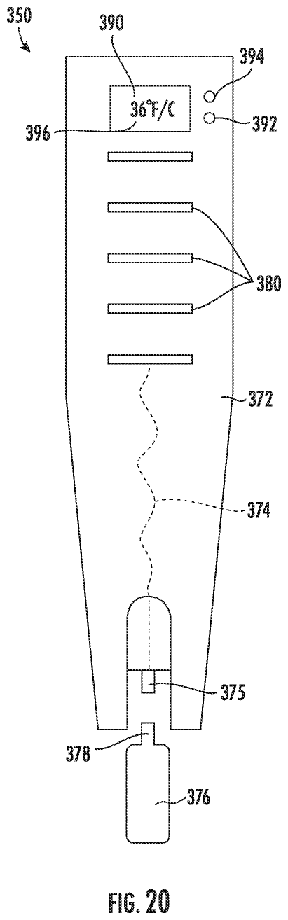

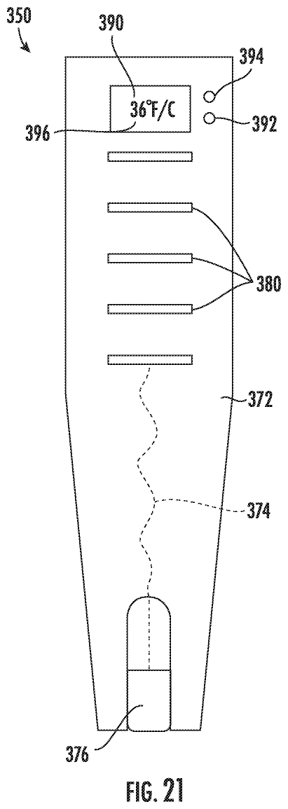

Another embodiment of the invention comprises a temperature regulating insert assembly, shown generally at reference numeral 350 in FIGS. 20 and 21. The insert assembly 350 can be used in a container, such as the container apparatus described in U.S. Pat. No. 10,088,147, which is incorporated herein by reference.

The insert assembly 350 comprises an elongate housing 372 that has tubing 374 positioned therein. Alternatively, a cooling coil can be used in place of the tubing 374. The tubing 374 can contain a refrigerant gel, such as a formulation of propylene glycol and water. Alternatively, other refrigerant compositions can be used, such as the refrigerant gel compositions described in U.S. Pat. No. 4,357,809, which is incorporated herein. The tubing 374 can be made of copper, or other suitable material. A gas dispensing device 376 can be attached to the housing 372, and is operatively connected to an opening 375 of the tubing 374, such that the gas dispensing device 376 can dispense gas into the tubing 374. The gas dispensing device 376 can dispense a pressurized stream of gas. The gas dispensing device 376 can be a cannister containing a pressurized cooling gas, such as a small version of a computer/electronics duster. Alternatively, the gas dispensing device 376 can comprise the vortex tube assembly described in U.S. Pat. No. 4,240,261, which is incorporated herein by reference. The gas dispenser 376 has a nozzle opening 378 through which the pressurized gas is expelled into the tubing 374 via tubing opening 375. The nozzle opening 378 of the gas dispenser 376 and tubing opening 375 are designed for complementary engagement. The nozzle opening 378 can be screwed on or snapped onto the tubing opening 375.

The gas dispersing device 376 contains a cooling gas, preferably having a temperature of −25 degrees Fahrenheit or lower. The gas can be carbon dioxide, freon, nitrogen gas, a fluorocarbon, such as difluoroethane, trifluoroethane, or tetrafluoroethane, or other suitable gas. A plurality of ventilation openings 380 are formed in the housing 372.

The insert assembly 350 can include a control module 390 positioned in the housing 372. The control module 390 comprises a computing device, such as a microcontroller. In addition, the control module 390 comprises a thermostat and a timer. The computing device is operatively connected to the thermostat and the gas dispenser 376. The control module 390 can include a power source for powering the microcontroller, thermostat and gas dispenser 376. The power source can be a battery. The battery can be a rechargeable battery and operatively connected to a charge port 392, whereby the battery can be recharged by plugging a power adaptor into the charge port 392. The control module can also include a USB port 394 for connecting to an external power source.

The control module 390 can include a touch screen display 396 by which a user can enter data into the control module 390. Alternatively, the control module 390 can include keys, buttons or other means for a user to enter data into the control module 390. The user can enter a desired temperature into the control module 390. The microcontroller of the control module 390 can be programmed with a non-transitory computer readable storage medium comprising software having programming instructions that, when executed, causes the microcontroller to electronically transmit signals to the gas dispenser 376 causing the gas dispenser 376 to emit cooling gas into the tubing 374 at timed intervals in order to achieve and maintain the desired temperature that has been entered by the user. The cooling gas travels through the tubing and is emitted through the vents 380 in the housing 372.

In a preferred embodiment, the control module 390 includes wireless technology, such as the wireless communication technology sold under the mark “BLUETOOTH”, which is operatively connected to the microcontroller. Software can be integrated into a mobile application that can be downloaded onto a mobile smartphone, whereby a user can enter a desired temperature via the mobile smartphone. The user can download the application at the APP STORE.

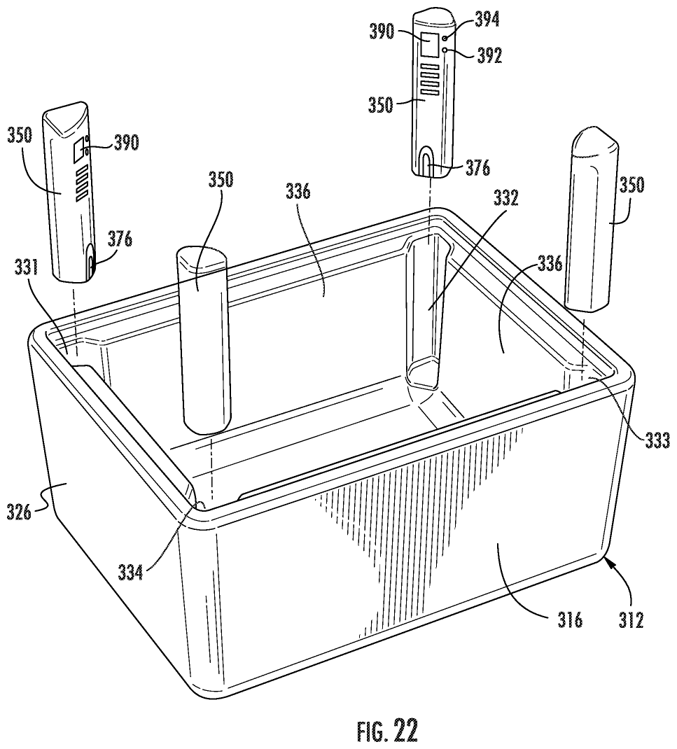

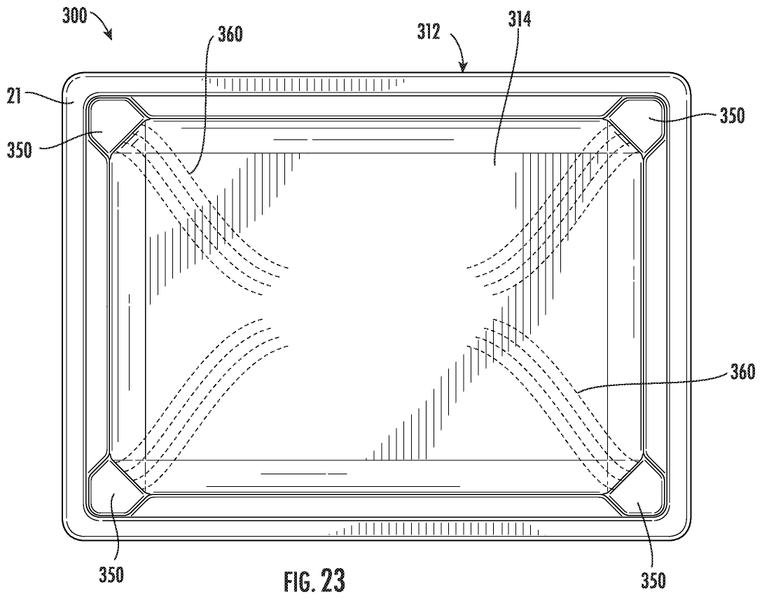

A temperature regulated container apparatus according to a preferred embodiment of the invention is illustrated in FIGS. 22 and 23, and shown generally at reference numeral 300. The container apparatus 300 comprises a container body 312 having an interior surface that is adapted for receiving and releasably maintaining the insert assembly 350 therein. The container 312 can be made of plastic or other suitable material, and can be made by injection molding or other suitable manufacturing process. The container 312 can be a thermally insulated cooler.

The container 312 can have a substantially rectangular base 314, and a substantially rectangular sidewall 316 extending upwardly from the base 314, as shown in FIGS. 22 and 23. The sidewall 316 has four sides defining four corners 321, 322, 323, 324. The sidewall 316 can include an outer wall section 326 and an inner wall section 336, as shown in FIG. 22. The surface of the base 314 and the surface of the inner wall section 336 define interior surfaces of the container 312. The top of the inner wall section is lower than the top of the outer wall section 326, thereby creating a tiered rest platform.

Four substantially concave and elongate recesses 331, 332, 333, 334 can be formed in the inner wall section 336 proximate the four corners of the sidewall 316, as shown in FIGS. 22 and 23. The recesses 331, 332, 333, 334 begin at the top of the inner wall section 336 and extend downwardly to the base 314 of the container 312.

The elongate recesses 331, 332, 333, 334 in the container 312 are sized and shaped to conform to the size and shape of the insert assembly 350, such that each recess 331, 332, 333, 334 can receive and retain an insert assembly 350 therein. Accordingly, the insert assembly 350 has a length approximately equal to the length of the recesses 331, 332, 333, 334, and have a perimeter slightly less than the effective perimeter of the recesses 331, 332, 333, 334, such that the insert assembly 350 can be inserted into the recesses 331, 332, 333, 334, as shown in FIGS. 22 and 23, and retained within the recesses 331, 332, 333, 334 by frictional engagement.

When the gas dispenser 376 dispenses cooling gas 360 into the tubing 374, the cooling gas 360 is emitted into the interior of the cooler 300, as shown in FIG. 23. When the thermostat detects that the temperature within the cooler has risen above the desired temperature, the microcontroller can send a signal to the gas dispenser 376 causing it to dispense another blast of cool gas into the housing 372.

In another preferred embodiment of the invention, the temperature regulating insert assembly 350 can be used as part of the container apparatus shown at reference numeral 300 in FIG. 20 of U.S. Pat. No. 10,088,147. In such an embodiment, the insert assembly 350 can be one or more of the elongate members 351, 352, 353, 354 that are received and releasably maintained within substantially concave recesses 331, 332, 333, 334 formed in the interior surface of the container apparatus 300 in FIG. 20 of U.S. Pat. No. 10,088,147. When the gas dispenser 376 dispenses cooling gas into the tubing 374, it is emitted into the interior of the cooler 300. When the thermostat detects that the temperature within the cooler 300 has risen above the desired temperature, the microcontroller can send a signal to the gas dispenser 376 causing it to dispense another blast of cool gas into the housing 372. The insert assembly 350 is not operatively connected to the container body 312. That is, the insert assembly 350 is not electrically connected to the container body 312 and can function independently from the container body 312. As such, insert assembly 350 can be easily removed from the container body 312 when desired. For example, the insert assembly 350 can be removed from the container body 312 for recharging of the insert assembly 350.

Another embodiment of the invention comprises a backpack having a recess that is shaped and sized to receive and releasably retain the temperature regulating insert assembly 350 therein. The insert assembly 350 can be easily removed from the backpack recess whenever desired. Another embodiment of the invention comprises an article of clothing, such as a shirt or jacket, having a recess that is shaped and sized to receive and releasably retain the insert assembly 350 therein. The insert assembly 350 can be easily removed from the recess in the clothing whenever desired. For example, the insert assembly 350 can be removed from the clothing in order to wash the clothing or when the ambient temperature is cold and the temperature regulating insert is not needed.

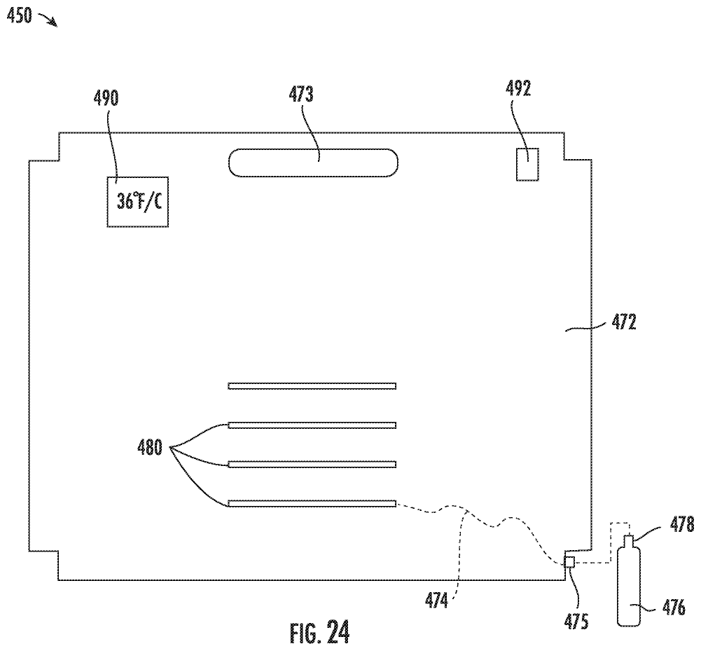

A temperature regulating insert assembly according to another embodiment of the invention is illustrated in FIG. 24, and shown generally at reference numeral 450. The insert assembly 450 can be used in a container apparatus, such as a container apparatus described in U.S. Pat. No. 10,088,147, which is incorporated herein by reference.

The insert assembly 450 comprises a substantially rectangular body 472 that has tubing 474 positioned therein. Alternatively, a cooling coil can be used in place of the tubing 474. The tubing 474 can contain a refrigerant gel, such as a formulation of propylene glycol and water. Alternatively, other refrigerant compositions can be used, such as the refrigerant gel compositions described in U.S. Pat. No. 4,357,809, which is incorporated herein by reference. The tubing 474 can be made of copper, or other suitable material. A gas dispensing device 476 can be attached to the body 472, and is operatively connected to an opening 475 of the tubing 474, such that the gas dispensing device 476 can dispense gas into the tubing 474. The gas dispensing device 476 can dispense a pressurized stream of gas. The gas dispensing device 476 can be a cannister containing a pressurized cooling gas, such as a small version of a computer/electronics duster. Alternatively, the gas dispensing device 476 can comprise the vortex tube assembly described in U.S. Pat. No. 4,240,261, which is incorporated herein by reference. The gas dispenser 476 has a nozzle opening 478 through which the pressurized gas is expelled into the tubing 474 via tubing opening 475. The nozzle opening 478 of the gas dispenser 476 and tubing opening 475 are designed for complementary engagement. The nozzle opening 478 can be screwed on or snapped onto the tubing opening 475.

The gas dispersing device 476 contains a cooling gas, preferably having a temperature of −25 degrees Fahrenheit or lower. The gas can be carbon dioxide, freon, nitrogen gas, a fluorocarbon, such as difluoroethane, trifluoroethane, or tetrafluoroethane, or other suitable gas. A plurality of ventilation openings 480 are formed in the body 472. An opening 473 can be formed in the body 472 to serve as a handle for the user.

The insert assembly 450 can include a control module 490 positioned on the body 472. The control module 490 comprises a computing device, such as a microcontroller, and a thermostat. The computing device is operatively connected to the thermostat and the gas dispenser 476. The control module 490 can include a power source for powering the microcontroller, thermostat and gas dispenser 476. The power source can be a battery. The battery can be a rechargeable battery and operatively connected to a charge port 492.

The control module 490 can include a touch screen display 496 by which a user can enter data into the control module 490. Alternatively, the control module 390 can include keys, buttons or other means for a user to enter data into the control module 490. The user can enter a desired temperature into the control module 490. The microcontroller of the control module 490 can be programmed with a non-transitory computer readable storage medium comprising software having programming instructions that, when executed, causes the microcontroller to electronically transmit signals to the gas dispenser 476 causing the gas dispenser 476 to emit cooling gas into the tubing 474 at timed intervals in order to achieve and maintain the desired temperature that has been entered by the user. The cooling gas travels through the tubing and is emitted through the vents 480 in the housing 472.

In a preferred embodiment, the control module 490 includes wireless technology, such as the wireless communication technology sold under the mark “BLUETOOTH”, which is operatively connected to the microcontroller. Software can be integrated into a mobile application that can be downloaded onto a mobile smartphone, whereby a user can enter a desired temperature via the mobile smartphone. The user can download the application at the APP STORE.

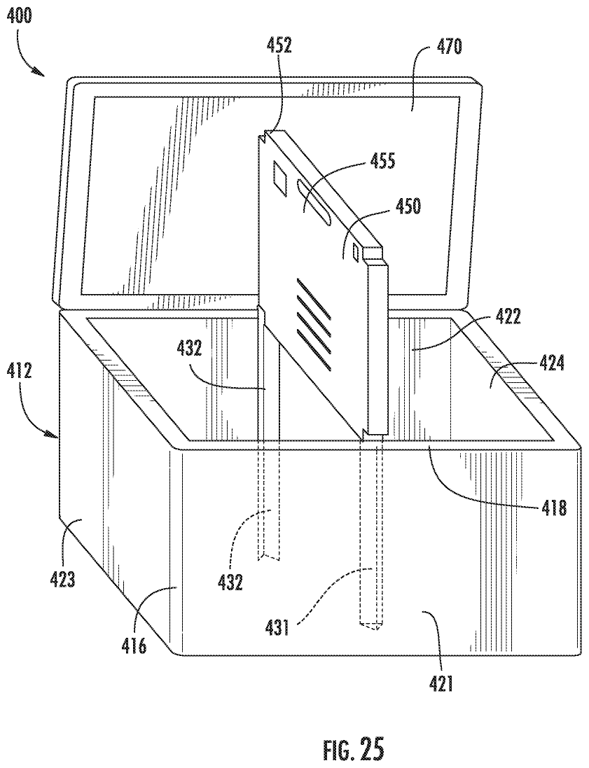

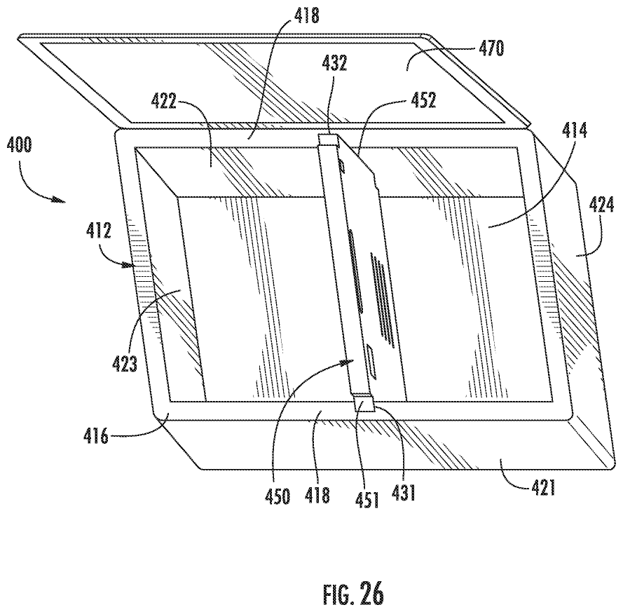

A temperature regulated container apparatus according to a preferred embodiment of the invention is illustrated in FIGS. 25 and 26, and shown generally at reference numeral 400. The apparatus 400 comprises a container body 412, and a lid 470 connected to the container body 412. The container body 412 and the lid 470 can be made of plastic or other suitable material, and can be made by injection molding or other suitable manufacturing process.

The container body 412 can comprise a substantially rectangular base 414 for positioning substantially horizontally on a floor surface, and a substantially rectangular sidewall 416 extending substantially vertically from the base 414. The sidewall 416 has four sides 421, 422, 423, 424. Two substantially concave and elongate recesses 431, 432 are formed in the interior surface on opposing sides 401, 402 of the sidewall 416, as shown in FIG. 22. The recesses 431, 432 define channels beginning at the top edge 418 of the sidewall 416 and extending downwardly to the base 414 of the container 412, as shown in FIG. 22. The channels 431, 432 extend substantially vertically, and are substantially perpendicular to the container base 414.

As shown in FIGS. 25 and 26, the insert assembly 450 can be slid into the opposed recessed channels 431, 432. When the gas dispenser 476 dispenses cooling gas into the tubing 474, it is emitted into the interior of the cooler 400. When the thermostat detects that the temperature within the cooler has risen above the desired temperature, the microcontroller can send a signal to the gas dispenser 476 causing it to dispense another blast of cool gas into the housing 472. The insert assembly 450 is not electrically connected to the cooler 400, and can be easily removed from the cooler when desired.

Another embodiment of the invention comprises a backpack having a recess that is shaped and sized to receive and releasably retain the temperature regulating insert assembly 450 therein. The insert assembly 450 can be easily removed from the backpack recess whenever desired. Another embodiment of the invention comprises an article of clothing, such as a shirt or jacket, having a recess that is shaped and sized to receive and releasably retain the insert assembly 450 therein. The insert assembly 450 can be easily removed from the recess in clothing whenever desired. For example, the insert assembly 450 can be removed from the clothing in order to wash the clothing or when the ambient temperature is cold and the temperature regulating insert is not needed.

A temperature regulated apparatus according to another embodiment of the invention is illustrated in FIG. 28, and shown generally at reference numeral 550. This apparatus 550 comprises a pad 572 or like member that has tubing 574 positioned therein. Alternatively, a cooling coil can be used in place of the tubing 574. The tubing 574 can contain a refrigerant gel, such as a formulation of propylene glycol and water. Alternatively, other refrigerant compositions can be used, such as the refrigerant gel compositions described in U.S. Pat. No. 4,357,809, which is incorporated herein. The tubing 574 can be made of copper, or other suitable material. A gas dispensing device 576 can be attached to the pad 572, and is operatively connected to an opening 575 of the tubing 574, such that the gas dispensing device 576 can dispense gas into the tubing 574. The gas dispensing device 576 can dispense pressurized stream of gas. The gas dispensing device 576 can be a cannister containing a pressurized cooling gas, such as a small version of a computer/electronics duster. Alternatively, the gas dispensing device 576 can comprise the vortex tube assembly described in U.S. Pat. No. 4,240,261. The gas dispenser 576 has a nozzle opening 578 through which the pressurized gas is expelled into the tubing 574.

The gas dispersing device 576 disperses a cooling gas, preferably having a temperature of −25 degrees Fahrenheit or lower. The gas can be carbon dioxide, freon, nitrogen gas, a fluorocarbon such as difluoroethane, trifluoroethane, or tetrafluoroethane, or other suitable gas.

The cooling pad apparatus 550 can include a control module 590 that can be attached to the pad 572. The control module 590 comprises a computing device, such as a microcontroller, and a thermostat. The computing device is operatively connected to the thermostat and the gas dispenser 576. The control module 590 can include a power source for powering the microcontroller, thermostat and gas dispenser 576. The power source can be a battery. The battery can be a rechargeable battery that is operatively connected to a USB port, whereby the battery can be recharged by plugging a power cord into the USB port.

The control module 590 can include a touch screen, keys, buttons or other means for a user to enter data into the control module 590. The user can enter a desired temperature into the control module 590. The microcontroller of the control module 590 can be programmed with a non-transitory computer readable storage medium comprising software having programming instructions that, when executed, causes the microcontroller to electronically transmit signals to the gas dispenser 576 causing the gas dispenser 576 to emit cooling gas into the tubing 576 at timed intervals in order to achieve and maintain the desired temperature that has been entered by the user.

According to a preferred embodiment, the control module 590 includes wireless technology, such as the wireless communication technology sold under the mark “BLUETOOTH”, which is operatively connected to the microcontroller. Software can be integrated into a mobile application that can be downloaded onto a mobile smartphone, whereby a user can enter a desired temperature via the mobile smartphone. The user can download the application at the APP STORE.

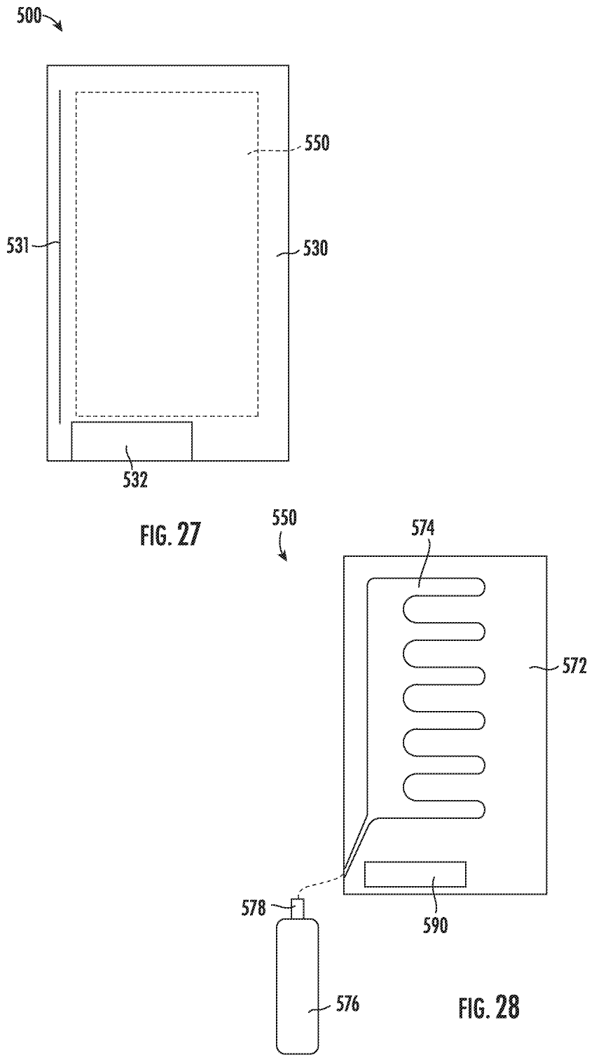

Another embodiment of the invention comprises a cooling system kit shown generally at reference numeral 500 in FIG. 27. The kit 500 comprises the cooling pad apparatus 550 and a blanket 530 adapted to receive the cooling pad 550. As shown in FIG. 27, the blanket 530 has a first opening 531 for receiving the cooling pad 550 therein. The blanket 530 has a relatively smaller second opening 532 by which the control module 590 of the cooling pad 550 can be accessed. The cooling pad 550 is not electrically connected to the blanket 530, and can be easily removed from the blanket 530 when desired.

Temperature regulated apparatuses and methods of using same are described above. Various changes can be made to the invention without departing from its scope. The above description of embodiments of the invention are provided for the purpose of illustration only and not limitation—the invention being defined by the claims and equivalents thereof.

What is claimed is:

1. A temperature regulated apparatus comprising:
(a) a layered member comprising a first layer of material and a second layer of material attached to the first layer, the layered member having a first opening formed therein and an interior area defined by the first layer and the second layer, the interior area in communication with the first opening; and
(b) a temperature regulating element adapted to alter the temperature of the layered member positioned within the interior area of the layered member, wherein the temperature regulating element is not operatively connected to the layered member and can be removed from the layered member without disassembling the layered member.

2. The temperature regulated apparatus according to claim 1, wherein the temperature regulated apparatus comprises a heating element adapted to heat the layered member.

3. The temperature regulated apparatus according to claim 2, wherein the heating element is selected from the group consisting of a flexible heating sheet and an electric heated blanket.

4. The temperature regulated apparatus according to claim 2, wherein the heating element includes a rechargeable battery for powering the heating element, and an electrical cord operatively connected to the rechargeable battery and a power source for charging the rechargeable battery.

5. The temperature regulated apparatus according to claim 4, wherein the layered member has a second opening formed therein, the second opening in communication with the interior area of the layered member, and the electrical cord can be positioned through the second opening.

6. The temperature regulated apparatus according to claim 1, wherein at least one of the first layer and the second layer comprise cushioning.

7. The temperature regulated apparatus according to claim 6, wherein the layered member comprises at least one selected from the group consisting of a pad, a bed and a seat cushion.

8. The temperature regulated apparatus according to claim 1, wherein the temperature regulating element is selected from the group consisting of a heating element adapted to increase the temperature of the layered member and a cooling element adapted to decrease the temperature of the layered member.

9. The temperature regulated apparatus according to claim 1, further comprising a non-permanent fastener for releasably closing the first opening.

10. The temperature regulated apparatus according to claim 9, wherein the non-permanent fastener comprises at least one from the group consisting of a magnet, a zipper, and hook and loop fasteners.

11. A temperature regulated apparatus comprising:
(a) a layered member comprising a heating section and a cooling section, the heating section defining a first side of the layered member and the cooling section defining a second side of the layered member opposite the first side, the layered member having a first opening in communication with a first interior area, and a second opening in communication with a second interior area;
(b) a heating element positioned within the first interior area, the heating element adapted to increase the temperature of the layered member, the heating element not operatively connected to the layered member and removable from the layered member without disassembling the layered member; and
(c) a cooling element positioned within the second interior area, the cooling element adapted to decrease the temperature of the layered member, the cooling element not operatively connected to the layered member and removable from the layered member without disassembling the layered member.

12. The temperature regulated apparatus according to claim 11, further comprising a cushioning section positioned intermediate the heating element and the cooling element, the cushioning section separating the first interior area from the second interior area of the layered member.

13. The temperature regulated apparatus according to claim 12, wherein the layered member comprises a first layer of material and a second layer of material connected to the first layer of material, the first layer and the second layer defining opposed exterior sides of the layered member.

14. The temperature regulated apparatus according to claim 13, wherein the cushioning section comprises at least one layer of material and is positioned intermediate the first layer and the second layer, the first layer and the cushioning section defining the first interior area of the layered member, and the second layer and the cushioning section defining the second interior area.

15. The temperature regulated apparatus according to claim 11, wherein the cooling element comprises a plurality of cooling members comprising a refrigerant gel, and the cooling section comprises a plurality of pockets sized and shaped to receive and retain the plurality of cooling members therein.

16. The temperature regulated apparatus according to claim 11, wherein the heating element is selected from the group consisting of a flexible heating sheet and an electric heated blanket.

17. A temperature regulated container apparatus comprising:
(a) a temperature regulating insert assembly comprising a housing and a gas contained in the housing that can alter an ambient temperature, the insert assembly adapted to dispense the gas through at least one opening formed in the housing; and
(b) an enclosure comprising a base and at least one sidewall extending upwardly from the base defining an interior area within the enclosure, the enclosure having an interior surface and at least one substantially concave recess formed in the interior surface adapted to receive the insert assembly therein, wherein the ambient temperature in the interior area of the enclosure is altered when the insert assembly dispenses the gas.

18. The temperature regulated container apparatus according to claim 17, wherein the temperature regulating insert assembly comprises a control module comprising a thermostat, the control module programmable to maintain a desired temperature within the interior area of the enclosure by causing gas to be dispensed from the housing to maintain the desired temperature within the interior area of the enclosure.

19. The temperature regulated container apparatus according to claim 17, wherein the gas comprises at least one from the group consisting of carbon dioxide, freon, nitrogen, difluoroethane, trifluoroethane, and tetrafluoroethane.

20. The temperature regulated container apparatus according to claim 17, wherein the enclosure comprises a thermally insulated cooler, and the temperature regulating insert assembly is not operatively connected to the cooler and is removable from cooler.
